(19) United States
(12) Patent Application Publication
(10) Pub. No.: US 2007/0296564 A1
(43) Pub. Date: Dec. 27, 2007

(54) Rear collision warning system

(76) Inventors: Mark N. Howell, Rochester Hills, MI (US); Youssef A. Ghoneim, Torslanda (SE); Sanjeev M. Naik, Troy, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/475,755

(22) Filed: Jun. 27, 2006

(51) Int. Cl. B60Q 1/00

(52) U.S. Cl. 340/435

(57) ABSTRACT

A control system for warning a following vehicle of a potential collision with a leading vehicle. The leading vehicle includes a detection system for detecting the presence and velocity of the following vehicle. The control system determines a desired distance between the leading vehicle and the following vehicle based on the speed of the leading vehicle. The control system subtracts the desired distance from the actual distance to generate a distance error signal, and compares the distance error signal to a threshold. If the error signal is greater than the threshold, the control system may provide one or more operations, such as flashing hazard lights to warn the following vehicle, or taking other course of action in the event of an imminent collision, such as pre-tensioning seat belts and closing windows of the leading vehicle.

### BACKGROUND OF THE INVENTION

1. Field of the Invention

This invention relates generally to a rear collision warning system for a vehicle and, more particularly, to a rear collision warning system for a vehicle that warns the driver in a following vehicle that a potential collision may occur with a leading vehicle.

2. Discussion of the Related Art

Many vehicles are equipped with various types of collision avoidance and warning systems, such as adaptive cruise control systems, rear-end collision avoidance systems and obstacle/pedestrian protection systems. However, most of these systems are designed to warn drivers of their potential collision with other vehicles and objects. It would be beneficial to provide a system that warned a following vehicle that was not equipped with collision technologies that there is a potential for running into the back end of a leading vehicle.

### SUMMARY OF THE INVENTION

In accordance with the teachings of the present invention, a control system is disclosed that warns a following vehicle of a potential collision with a leading vehicle. The leading vehicle may be equipped with a rear collision warning system that can determine the range and range rate of the following vehicle. The control system employs an algorithm that detects the following vehicle and determines whether the potential exists for a collision with the leading vehicle. The algorithm compares a desired distance between the leading vehicle and the following vehicle based on the speed of the leading vehicle, and determines whether the difference between the desired distance and the actual distance is greater than a predetermined threshold. If the difference is greater than the threshold, the algorithm may provide one or more operations, such as flashing hazard lights to warn the following vehicle, or taking other courses of action in the event of an imminent collision, such as pre-tensioning seat belts and closing windows of the leading vehicle.

Additional features of the present invention will become apparent from the following description and appended claims taken in conjunction with the accompanying drawings.

### BRIEF DESCRIPTION OF THE DRAWINGS

FIG. 1 is a plan view of a vehicle including a rear collision system;

FIG. 2 is a plan view of a leading vehicle and a following vehicle;

FIG. 3 is a block diagram of a control system for warning a following vehicle of a potential collision with a leading vehicle, according to an embodiment of the present invention; and

FIG. 4 is a flow chart diagram showing the operation of a collision warning algorithm of the invention.

### DETAILED DESCRIPTION OF THE EMBODIMENTS

The following discussion of the embodiments of the invention directed to a control system for warning a following vehicle of an potential collision with a leading vehicle is merely exemplary in nature, and is in no way intended to limit the invention or its applications or uses.

FIG. 1 is a top view of a vehicle 10 including a controller 12 and a rear vision system 14. The rear vision system 14 includes radar sensors 16 that emit radar beams 18 behind the vehicle 10. In one particular design, the sensors 16 are mid-range sensors that emit the beams 18 to about 15 meters. Various vehicle collision warning systems are known in the art that employ radar sensors for collision avoidance and the like. The present invention proposes using such systems in combination with a system that alerts a following vehicle of a potential collision with the vehicle 10. In other collision avoidance systems, the radar sensors 16 can be replaced with other types of sensors, such as ultrasonic sensors.

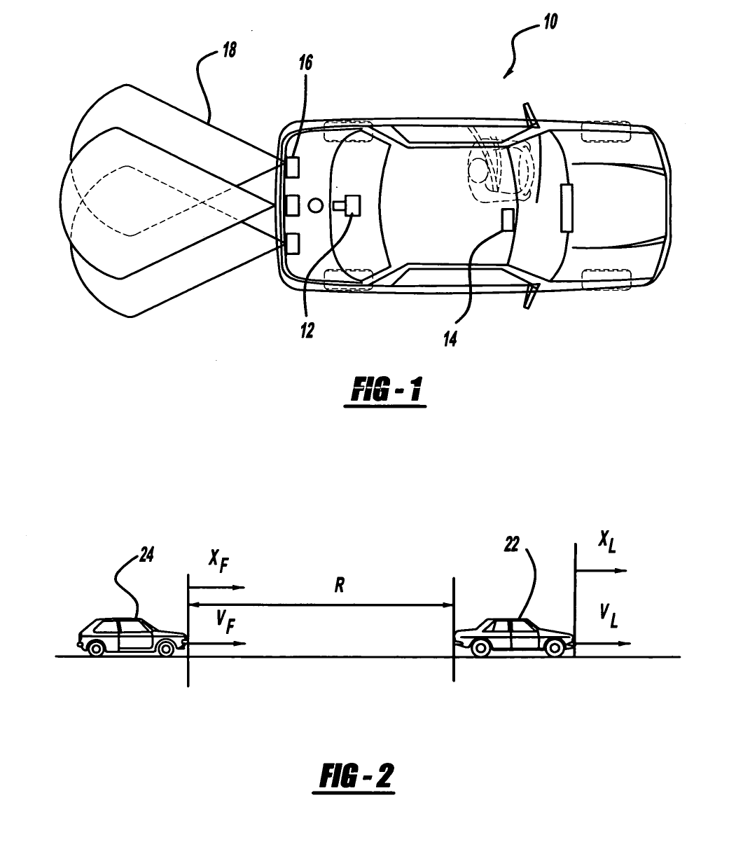

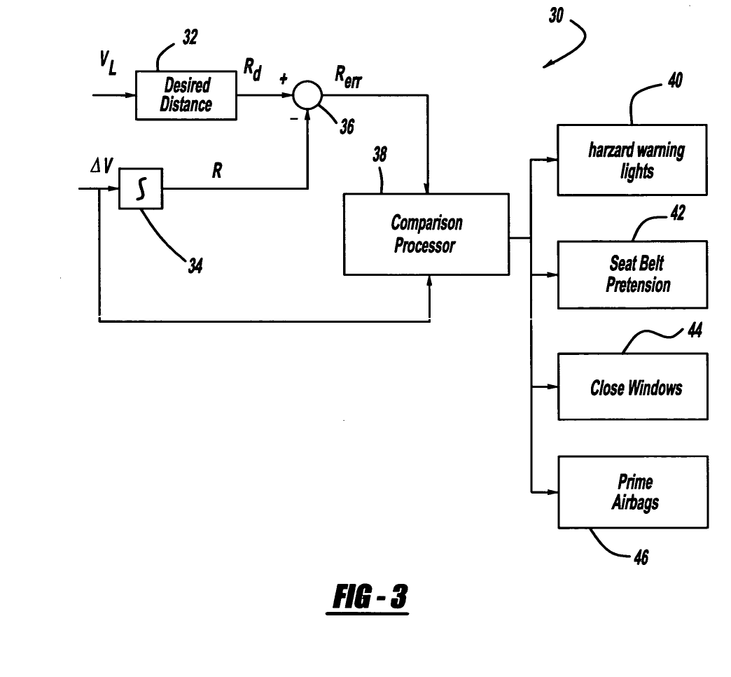

FIG. 2 is a diagram of a leading vehicle 22 and a following vehicle 24 that are a distance R apart. The present invention proposes an algorithm for determining if the following vehicle 24 is closing too quickly on the leading vehicle 22 and providing an alert to the driver of the following vehicle 24 of a potential collision. To perform the calculations, the algorithm will use various parameters including the distance R, the closing rate of the following vehicle 24, the velocity V_{L} of the leading vehicle 22, the velocity V_{F} of the following vehicle 24, the position X_{L} of the leading vehicle 22 and the position X_{F} of the following vehicle 24. As would be well understood to those skilled in the art, the rear vision system 14 and the controller 12 that may be equipped on the leading vehicle 22 would be capable of determining the distance R and the distance rate between the leading vehicle 22 and the following vehicle 24.

For the algorithm of the invention, the following equations can be used. The distance R is defined as:

R=X_{L}−X_{F}−L_{L} (1)

### Where L_{L} is the length of the leading vehicle 22.

A desired spacing between the leading vehicle 22 and the following vehicle 24 is determined based on the velocity V_{L} of the leading vehicle 22 and a time gap constant τ as:

R_{d}=V_{L}τ (2)

A distance error Rₑᵣᵣ is defined as the difference between the desired distance R_{d} and the actual distance R as:

Rₑᵣᵣ=R_{d}−R (3)

The relative velocity ΔV or (V_{L}−V_{F}) between the leading vehicle 22 and the following vehicle 24 is defined as:

$$\dot{R} = \frac{d R}{d t} = ( {V}_{L} - {V}_{F} ) \qquad ( 4 )$$

Equations (1)-(4) can be used to provide the following state space formulation that represent the state space model for the leading vehicle 22 and the following vehicle 24.

$$\begin{matrix}{R}_{err} = {V}_{F} τ - ( {X}_{L} - {X}_{F} - {L}_{L} ) & ( 5 ) \\ {\dot{R}}_{err} = {\dot{V}}_{L} τ - ( Δ V ) = {a}_{L} τ - Δ V & ( 6 ) \\ Δ \dot{V} = ( {\dot{V}}_{L} - {\dot{V}}_{F} ) = {a}_{L} - {a}_{F} & ( 7 ) \\ [ \begin{matrix}{\dot{R}}_{err} \\ Δ \dot{V}\end{matrix} ] = [ \begin{matrix}0 & - 1 \\ 0 & 0\end{matrix} ] [ \begin{matrix}{R}_{err} \\ Δ V\end{matrix} ] + [ \begin{matrix}τ \\ - 1\end{matrix} ] {a}_{L} + [ \begin{matrix}0 \\ 1\end{matrix} ] {a}_{F} & ( 8 )\end{matrix}$$

Where a_{L} and a_{F} are the acceleration of the leading vehicle 22 and the following vehicle 24, respectively. This can be written in compact state space notation as:

\dot{x}=Ax+ba_{L}+dω (9)

### Where x is system states of Rₑᵣᵣ and ΔV, A is a constant matrix, b and d are constant vectors and ω is an error term because the following vehicle acceleration will not be known, although it can be estimated.

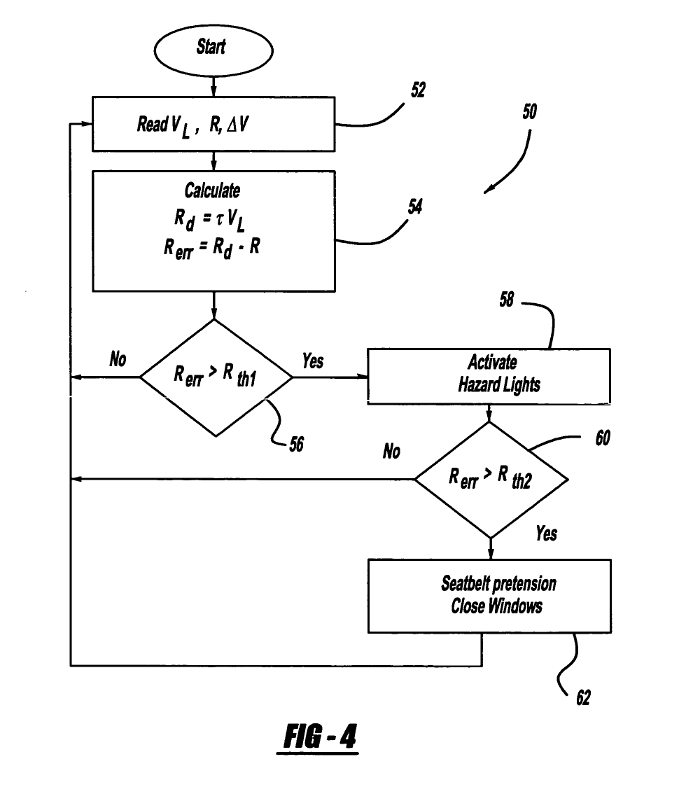

The control strategy for generating the warning to the following vehicle 24 depends on the distance error Rₑᵣᵣ and the relative velocity ΔV between the leading vehicle 22 and the following vehicle 24. FIG. 3 is a block diagram of a control system 30, according to an embodiment of the present invention. The velocity V_{L} of the leading vehicle 22 is sent to a desired distance processor 32 that calculates the desired distance R_{d} between the leading vehicle 22 and the following vehicle 24 based on equation (2). The desired distance processor 32 can also consider wheel slip for slick road conditions, such as wet or icy road conditions, so as to set the desired distance R_{d} accordingly. The relative velocity ΔV between the leading vehicle 22 and the following vehicle 24 is integrated by an integrator 34 to generate the distance signal R per equation (4) as the difference in the distance between the leading vehicle 22 and the following vehicle 24 changes. An estimate of the relative velocity provides additional information that can indicate if the following vehicle 24 is slowing down or a collision is imminent, and can be used to estimate the potential time of occurrence of a collision. This can be used to provide additional conditions at which to activate the various stages of warning alerts in vehicle pre-crash systems.

The desired distance R_{d} and the actual distance R between the leading vehicle 22 and the following vehicle 24 are compared by a comparator 36 to generate the distance error signal Rₑᵣᵣ. A comparison processor 38 uses the error signal Rₑᵣᵣ to determine whether the following vehicle 24 is closing too fast on the leading vehicle 22. If the error signal Rₑᵣᵣ is greater than a first threshold, the system 30 may flash the hazard lights and/or the brake lights at box 40 to provide a collision warning to the driver of the following vehicle 24. If the error signal Rₑᵣᵣ is greater than a second threshold, the comparison processor 38 may take other actions for an imminent collision, such as pre-tensioning seatbelts at box 42, closing the windows at box 44, priming the air bags at box 46, etc.

FIG. 4 is a flow chart diagram 50 showing the control algorithm of the invention for warning the driver of the following vehicle 24 in the manner as discussed above. At box 52, the algorithm reads the velocity V_{L} of the leading vehicle 22, the distance R between the leading vehicle 22 and the following vehicle 24, and the relative speed ΔV between the leading vehicle 22 and the following vehicle 24. The algorithm then calculates the desired distance R_{d} and the error signal Rₑᵣᵣ using equations (2) and (3) at box 54. The algorithm then determines if the error signal Rₑᵣᵣ is greater than a first threshold R_{TH1} at decision diamond 56. In one embodiment, the threshold R_{TH1} may be about 5 meters. If the error signal Rₑᵣᵣ is not greater than the threshold R_{TH1} then the algorithm returns to reading the signals at the box 52. If the error signal Rₑᵣᵣ is greater than the first threshold R_{TH1}, then the algorithm activates the hazard lights at box 58. The algorithm then determines whether the error signal Rₑᵣᵣ is greater than a second threshold R_{TH2} at decision diamond 60, and if not, returns to reading the signals at the box 52. If the error signal Rₑᵣᵣ is greater than the second threshold R_{TH2} at the decision diamond 60, then the algorithm takes the imminent collision actions, such as pre-tensioning the seatbelts, closing the windows, priming the air bags, etc. at box 62.

In an alternate embodiment of the present invention, the leading vehicle 22 does not include a rear vision system having radar sensors or ultrasonic sensors. In this embodiment, the leading vehicle 22 would flash the brake and/or the hazard lights based solely on the hardness of the braking of the vehicle by the vehicle operator of the leading vehicle 22. For example, a controller in the leading vehicle 22 may compare the brake pressure applied by the vehicle operator of the leading vehicle 22 to a predetermined threshold, and if that threshold is exceeded, provide the warning operation. Further, the amount of wheel slip can also be used in combination with the braking hardness to determine whether the brake lights and hazard lights will be flashed to warn the following drivers.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for warning a following vehicle by a leading vehicle of a potential rear end collision, said method comprising:
determining a desired distance between the leading vehicle and the following vehicle based on the velocity of the leading vehicle;
continuously determining the actual distance between the leading vehicle and the following vehicle based on the relative velocity between the leading vehicle and the following vehicle;
subtracting the desired distance from the actual distance to generate a distance error signal;
comparing the distance error signal to a first threshold; and
performing a warning function if the distance error signal is greater than the first threshold.

2. The method according to claim 1 wherein performing a warning function includes flashing hazard lights of the leading vehicle.

3. The method according to claim 1 further comprising comparing the distance error signal to a second threshold if the distance error signal is greater than the first threshold, and performing an imminent collision function if the error signal exceeds the second threshold.

4. The method according to claim 3 wherein the imminent collision function includes one or more of pre-tensioning seatbelts, closing windows and priming airbags.

5. The method according to claim 1 wherein determining the relative velocity between the leading vehicle and the following vehicle includes using radar or ultrasonic sensors on the leading vehicle.

6. The method according to claim 1 wherein determining a desired distance includes multiplying the velocity of the leading vehicle by a time gap constant.

7. The method according to claim 1 wherein determining the desired distance includes considering wheel slip of the leading vehicle to determine road conditions.

8. A system for warning a following vehicle by a leading vehicle of a potential rear end collision, said system being on the leading vehicle, said system comprising:
at least one sensor for detecting the following vehicle, said at least one sensor providing a sensor signal indicative of the changing distance between the leading vehicle and the following vehicle;
a controller responsive to the sensor signal and providing a warning signal if a potential for a rear end collision exists, said controller determining a desired distance between the leading vehicle and the following vehicle based on the velocity of the leading vehicle, said controller continuously determining the actual distance between the leading vehicle and the following vehicle based on the relative velocity between the leading vehicle and the following vehicle using the sensor signal, said controller subtracting the desired distance from the actual distance to generate a distance error signal, and said controller comparing the distance error signal to a first threshold and generating a warning signal if the distance error signal is greater than the first threshold; and
a device responsive to the warning signal that provides a visual indication to the following vehicle of the potential collision.

9. The system according to claim 8 wherein the device is hazard lights or brake lights on the leading vehicle.

10. The system according to claim 8 wherein the controller determines the desired distance by multiplying the velocity of the leading vehicle by a time gap constant.

11. The system according to claim 8 wherein the controller considers wheel slip of the leading vehicle to determine road condition when determining the desired distance between the leading vehicle and the following vehicle.

12. The system according to claim 8 wherein the controller compares the distance error signal to a second threshold if the distance error signal exceeds the first threshold, said controller performing an imminent collision function if the error signal exceeds the second threshold.

13. The system according to claim 12 wherein the imminent collision function includes one or more of pre-tensioning seat belts, closing windows and priming air bags on the leading vehicle.

14. The system according to claim 8 wherein the at least one sensor is selected from the group consisting of radar sensors and ultrasonic sensors.

15. The system according to claim 8 wherein the at least one sensor is a mid-range sensor.

16. A method for warning a following vehicle by a leading vehicle of a potential rear end collision, said method comprising:
determining whether a vehicle operator of the leading vehicle has provided brake pressure beyond a predetermined threshold; and
flashing hazard lights on the leading vehicle if the brake pressure does exceed the predetermined threshold.

17. The method according to claim 16 further comprising changing the predetermined threshold in response to a wheel slip that indicates slippery road conditions.

18. A system for warning a following vehicle by a leading vehicle of a potential rear end collision, said system being on the leading vehicle, said system comprising:
a controller responsive to a brake pressure signal and providing a warning signal if the brake pressure signal exceeds a predetermined threshold; and
a device responsive to the warning signal that provides a visual indication to the following vehicle of the potential collision.

19. The system according to claim 18 wherein the device is hazard lights or brake lights on the leading vehicle.

20. The system according to claim 18 wherein the controller modifies the predetermined threshold in response to a wheel slip that indicates slippery road conditions.
